(19) United States
(12) Patent Application Publication
(10) Pub. No.: US 2014/0345415 A1
(43) Pub. Date: Nov. 27, 2014

(54) ACCELERATOR PEDAL OF VEHICLE

(71) Applicants: Hyundai Motor Company, Seoul (KR); DONG HEE INDUSTRIAL CO., LTD., Ulsan (KR)

(72) Inventors: Eun Sik Kim, Gwangmyeong-si (KR); Bum Jun Kim, Bucheon-si (KR); Hee Soo Yang, Busan (KR); Jee Hyuck Choi, Gunpo-si (KR); Yang Rae Cho, Suwon-si (KR); Jeong Seon Min, Gwangju (KR); Young Seok Song, Busan (KR)

(73) Assignees: DONG HEE INDUSTRIAL CO., LTD., Ulsan (KR); Hyundai Motor Company, Seoul (KR)

(21) Appl. No.: 13/960,363

(22) Filed: Aug. 6, 2013

(30) Foreign Application Priority Data
May 27, 2013 (KR) 10-2013-0059454

(51) Int. Cl. G05G 1/44

(52) U.S. Cl. CPC G05G 1/44
USPC 74/513

(57) ABSTRACT

An accelerator pedal for a vehicle includes: a foot pad to which a pedal effort is applied by a driver; a cover which is connected to correspondingly thereto; a vibration producer which is disposed between the foot pad and the cover and is vibrated by an electric signal; and a vibration transmitter which is extended in a longitudinal direction of the foot pad.

### CROSS-REFERENCE TO RELATED APPLICATION

The present application claims priority of Korean Patent Application Number 10-2013-0059454 filed May 27, 2013, the entire contents of which application is incorporated herein for all purposes by this reference.

### BACKGROUND OF INVENTION

1. Field of Invention

The present disclosure relates to an accelerator pedal for a vehicle through which a distinct alarm function as well as a good feeling may be provided to a driver of a vehicle by transferring a vibration to the entire pad evenly when applying an electric signal thereto.

2. Description of Related Art

Generally, an accelerator pedal device for a vehicle adjusts engine rpm by controlling intake amount of a mixer in a gasoline engine, and by controlling injection amount of fuel in a diesel engine.

The accelerator pedal device may be divided into a pendant type which is installed with being hung on a dash panel and an organ type which is installed on a floor panel depending on installment types.

Among the accelerator pedal devices, a mechanical accelerator pedal device which controls the combustion amount by opening/closing a throttle valve within a carburetor with an accelerating cable has been most widely used currently. Recently, an electronic accelerator pedal device is developed by converting various controls applied to an engine and peripherals into electronic signals.

In relation with this, Korean Patent Laid-Open No. 10-2007-0000345 entitled “An accelerator pedal of a motor car” may be referred to.

In the conventional art, when the driver steps down on a pad on a general mode, a clutch disk rotates for a spring which is connected to an acceleration cable to form a pedal effort, and then a sensor senses rotational amount and sends an accelerator pedal signal to ECU. At this time, on ECU mode, a stator becomes an electromagnet to be polarized, and the driver steps off from the pad after feeling the pedal effort while providing a force to prevent the clutch disk from being rotated by a rotation of a rotor, thereby reducing fuel consumption. However, under the conventional art, cost of the product increases since a configuration of the accelerator pedal is complicated and excessive numbers of components are used, and noise is produced owing to its structure wherein the rotor and the clutch disk are coupled and decoupled.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention have been made in an effort to solve the above-described problems associated with prior art. Various aspects of the present invention provide for an accelerator pedal for a vehicle, enabling to transfer evenly a vibration to the entire pad when applying an electric signal.

Various aspects of the present invention provide for an accelerator pedal for a vehicle which may includes: a pad to which a pedal effort is applied by a driver; a cover which is connected to the pad correspondingly thereto; a vibration producer which is disposed between the pad and the cover and is vibrated by an electric signal; and a vibration transmitter which is extended in a longitudinal direction of the pad to transfer evenly the vibration from the vibration producer to an entire surface of the pad.

The vibration transmitter may include a vibrating case on which the vibration producer is seated and at least one of transition rod which is connected to the vibrating case so as to be extended in a longitudinal direction of the pad.

The vibration transmitter may include vibrating ribs at least a part of which gets in touch with the vibration producer and which are extended in a longitudinal direction of the pad.

The pad may include an external pad to which a pedal effort is applied and an internal pad which is disposed at a rear surface of the external pad, and the cover comprises an internal cover which is closely adhered to the internal pad, leaving the vibration producer therebetween, and an external cover which is disposed at a rear surface of the internal cover.

The internal pad and the internal cover may be composed of an elastic member for soundproofing and noise reduction.

The accelerator pedal for a vehicle may further include a wiring to transmit the electric signal to the vibration producer.

The wiring may include a curved portion curved at a part of the pad, which is rotated by a pedal effort, and an angled portion angled from the curved portion to be overlapped on the curved portion.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing an exemplary accelerator pedal for a vehicle according to the present invention;

FIG. 2 is an exploded perspective view showing an accelerator pedal for a vehicle according to the present invention;

FIG. 3 is a plan view showing an accelerator pedal for a vehicle according to the present invention;

FIG. 4 is a side view showing an accelerator pedal for a vehicle according to the present invention;

FIG. 5 is a partial sectional view showing an accelerator pedal for a vehicle according to the present invention;

FIG. 6 is a perspective view showing an accelerator pedal for a vehicle according to the present invention;

FIG. 7 is an exploded perspective view showing an accelerator pedal for a vehicle according to the present invention;

FIG. 8 is a plan view showing an accelerator pedal for a vehicle according to the present invention; and

FIG. 9 is a side view showing an accelerator pedal for a vehicle according to the present invention.

It should be understood that the appended drawings are not necessarily to scale, presenting a somewhat simplified representation of various features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The accelerator pedal of various embodiments of the present invention may transmit evenly the vibration to the entire pad with receiving an electric signal from a controller (e.g., ECU, HCU and other units) within a vehicle.

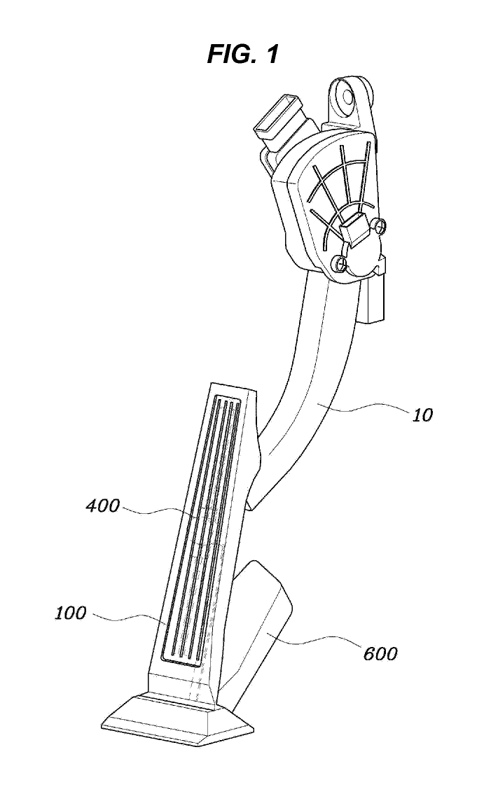

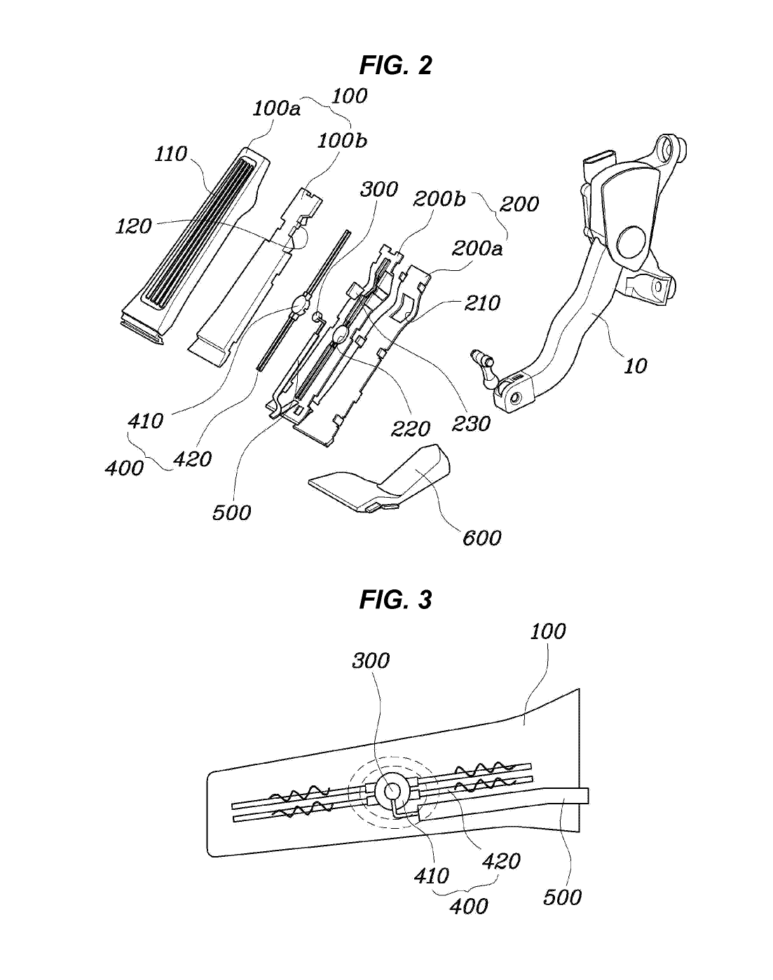

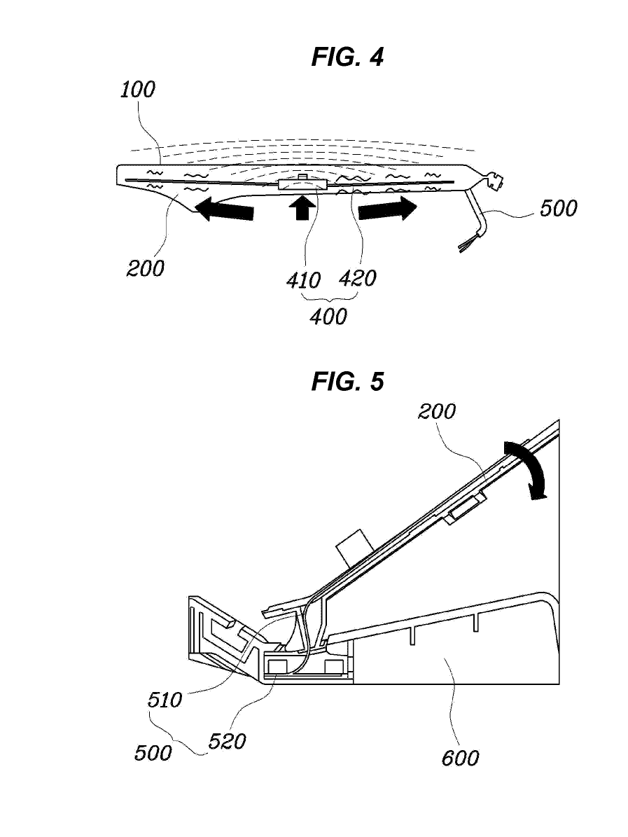

FIG. 1 is a perspective view showing an accelerator pedal for a vehicle according to various embodiments of the present invention, FIG. 2 is an exploded perspective view showing an accelerator pedal for a vehicle according to various embodiments of the present invention, FIG. 3 is a plan view showing an accelerator pedal for a vehicle according to various embodiments of the present invention and FIG. 4 is a side view showing an accelerator pedal for a vehicle according to various embodiments of the present invention.

As shown in FIGS. 1 to 4, the accelerator pedal for a vehicle according to various embodiments of the present invention includes a pad 100, a cover 200, a vibration producer 300 and a vibration transmitter 400. In various embodiments of the present invention, even though an organ type that the accelerator pedal is connected rotatably to a pedal arm 10 connected to an accelerating cable in order to transfer a driver's input or pedal effort to an accelerator cable, is applied thereto, and it is not limited thereto but various types such as a pendant type, a pendant organ type or box shape organ type, etc., may be applied thereto.

In more detail, the pad 100 is a part to which a pedal effort is directly applied by a driver, and the pedal effort applied to this pad 100 may be transferred to the accelerating cable through the pedal arm 10. For this purpose, the pedal arm 10 to which the accelerator pedal is connected rotatably may be connected to an upper portion of the pad 100 and an lower portion of the pad 100 may be mounted to a floor panel at a lower part of a driver's seat using a connector 600.

The pad 100 includes an external pad 100a to which a pedal effort is applied directly and an internal pad 100b that is disposed at a rear surface of the external pad 100a. The external pad 100a constitutes an external part of a front surface of the accelerator pedal, and is connected to an external cover 200a, which will be described later. Here, a plurality of pad ribs 110 for preventing slippage of a driver are protruded in longitudinal direction on the front of the external pad 100a. Additionally, the internal pad 100b is composed of an elastic member such as rubber for soundproofing and noise reduction. At both sides of the internal pad 100b, catching grooves 120 to which catching jaws 230 of the internal cover 200b, which will be described later, are inserted are formed.

The cover 200 is connected to a rear surface of the pad 100, and a vibration producer 300 and a vibration transmitter 400 are disposed between the cover 200 and the pad 100.

The cover 200 is connected correspondently at the rear surface of the pad 100, and a through-hole 210 into which an end of the pedal arm 10 is inserted is formed through the cover. The through -hole 210 is extended in a longitudinal direction such that a sufficient space for the pedal arm 100 to move about is provided.

The cover 200 includes an internal cover 200b to be in close contact with the internal pad 100 and an external cover 200a to be disposed at the rear surface of the internal cover 200b. The external cover 200a constitutes an external part of the rear surface of the accelerator pedal, and is connected to the external pad 100a.

Additionally, the internal cover 200b closely adheres to the internal pad 100b and is composed of an elastic member such as rubber. The catching jaws 120 that are inserted into the catching grooves 230 are protruded at both sides of the internal cover 200b.

Moreover, a seating groove 220 on which the vibration producer 300 and the vibration transmitter 400 are seated may be formed on a front surface of the internal cover 200b. The seating groove 220 is configured as a groove structure, corresponding to the shapes of the vibration producer 300 and the vibration transmitter 400. For example, the vibration producer 300 and the vibration transmitter 400 are arranged to be buried in the internal cover 200b, not to protrude therefrom.

Of course, even though the vibration producer 300 and the vibration transmitter 400 are buried in a front surface of the internal cover 200b in various embodiments, however, the vibration producer 300 and the vibration transmitter 400 may be buried in the internal pad 100b facing to the internal cover 200b or at least a part of them may be buried in the internal cover 200b and the internal pad 100b.

The vibration producer 300 is vibrated by receiving electric signal from a controller (e.g., ECU, HCU and other units) within a vehicle, and is disposed between the pad 100 and the cover 200. For example, when a pedal effort increases with pressing excessively an accelerator pedal by a driver, a controller within the vehicle may warn the driver of a condition of an excessive pedal effort with applying an electric signal to the vibration producer 300 and vibrating the accelerator pedal.

The vibration producer 300 may receive an electric signal from a controller through a wiring or conductor 500.

FIG. 5 is a partial sectional view showing an accelerator pedal for a vehicle according to various embodiments of the present invention.

As shown in FIG. 5, the wiring 500 may include a curved portion 510 and an angled portion 520 in order to transfer smoothly an electric signal from a controller to the vibration producer 300. The curved portion 510 may be curved at a part of the pad 100, which is rotated by a pedal effort, and the angled portion 520 may be angled from the curved portion 510 to be overlapped on the curved portion 510.

Specially, the vibration transmitter 400 may provide a distinct alarm function as well as a good feeling to a driver of a vehicle by transferring evenly a vibration to the entire pad 100 by means of the vibration transmitter 400.

The vibration transmitter 400 may be extended in a longitudinal direction of the pad 100, and thereby transferring a vibration of the vibration producer 300 to the entire surface of the pad 100. The vibration transmitter 400 includes a vibrating case 410 on which the vibration producer 300 is seated and at least one of transition rod 420 that is connected to the vibrating case 410 and extended in a longitudinal direction of the pad 100.

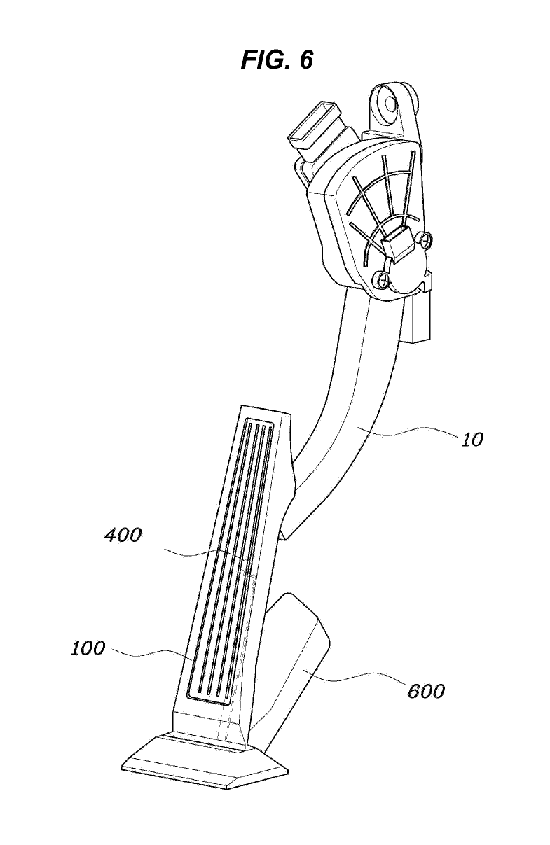

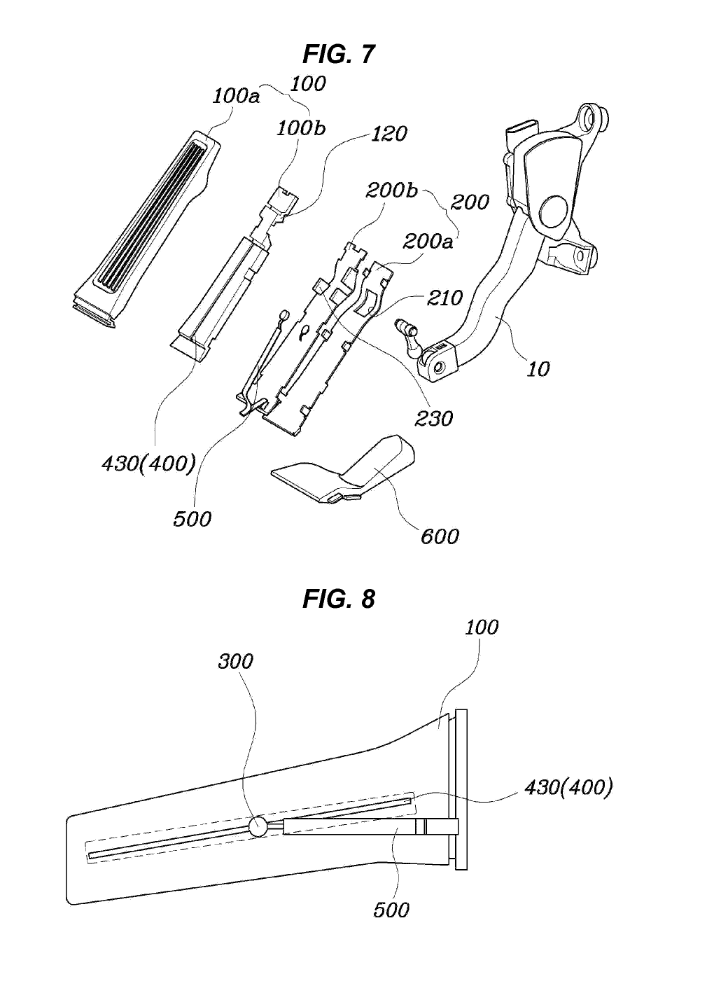

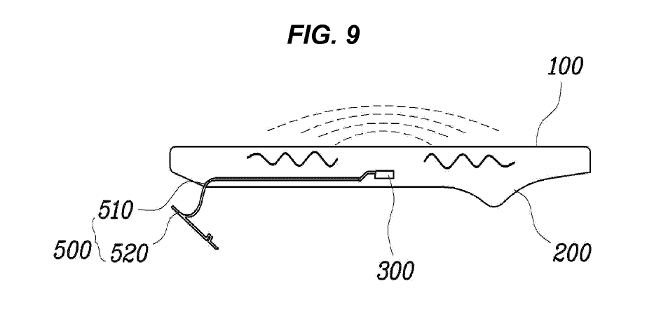

FIG. 6 is a perspective view showing an acceleration pedal for a vehicle according to various embodiments of the present invention, FIG. 7 is an exploded perspective view showing an acceleration pedal for a vehicle according to various embodiments of the present invention, FIG. 8 is a plan view showing an acceleration pedal for a vehicle according to various embodiments of the present invention, and FIG. 9 is a side view showing an acceleration pedal for a vehicle according to various embodiments of the present invention.

As shown in FIGS. 6 to 9, in an accelerator pedal according to various embodiments of the present invention, the vibration transmitter 400 may include vibrating ribs 430 that are extended in a longitudinal direction of the pad 100.

Here, the remaining configurations except for the vibration transmitter 400, for example, the configurations of the pad 100, the cover 200 and the vibration producer 300 are substantially identical or similar to the aforesaid configurations of the pad 100, the cover 200 and the vibration producer 300, and thus detailed description thereof will be omitted.

The vibrating ribs 430 each has a rib structure wherein at least a part of the vibrating rib 430 gets in touch with the vibration producer 300. A plurality of vibrating ribs are protruded on a front surface of the internal pad 100b and extended in a longitudinal direction. At this time, the vibration producer 300 may be buried in the internal pad 100b.

Accordingly, when a controller applies an electric signal to the vibration producer 300, the vibration producer 300 is vibrated by receiving the electric signal, and the vibration transmitter 400 may vibrate evenly the entire surface of the accelerator pedal by transferring the vibration in a longitudinal direction of the pedal.

In various embodiments, even though the vibration transmitter 400 is configured such that the vibrating case 410 and the transition rod 420 are connected, or as the vibrating ribs 430, however it may be configured as various types within a technological range which may transfer evenly a vibration of the vibration producer 300 to the entire surface of the pad.

According to an accelerator pedal for a vehicle configured as described above, when applying an electric signal using a controller within a vehicle, the accelerator pedal may provide a distinct alarm function as well as a good feeling to a driver of a vehicle by transferring evenly a vibration to the entire pad, and further a vibration is simply transmitted in an acceleration pedal, thereby reducing the duration of vibration and implement easily trembling mode or high frequency vibration mode.

According to the accelerator pedal for a vehicle as configured above, a distinct alarm function as well as a good feeling can be provided to a driver of a vehicle by transferring evenly a vibration to the entire pad when applying an electric signal using a controller within the vehicle.

Additionally, a vibration can be simply transmitted in an acceleration pedal, thereby reducing the duration of vibration and implementing easily trembling mode or high frequency vibration mode. Moreover, a pleasant driving environment can be provided to a driver since noises that are produced when a conventional stator and a rotor are operated can be prevented, and driver's fatigue can be alleviated.

For convenience in explanation and accurate definition in the appended claims, the terms upper, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An accelerator pedal for a vehicle comprising:
a foot pad configured to receive a driver's pedal effort;
a cover extending along a rear surface of the foot pad;
a vibration producer disposed within a space defined by the foot pad and the cover, the vibration producer being controlled by an electric signal; and
a vibration transmitter extending in a longitudinal direction of the foot pad to transmit vibration from the vibration producer to the foot pad, the vibration transmitter extending along the rear surface of the foot pad.

2. The accelerator pedal for a vehicle of claim 1, wherein the vibration transmitter comprises a vibrating case on which the vibration producer is seated, and at least one transition rod connected to the vibrating case extending in a longitudinal direction of the foot pad.

3. The accelerator pedal for a vehicle of claim 1, wherein the vibration transmitter comprises vibrating ribs, wherein at least a part of said vibrating ribs contacts the vibration producer and the said vibrating ribs extend in a longitudinal direction of the foot pad.

4. The accelerator pedal for a vehicle according to claim 1, wherein the foot pad comprises an external pad configured to receive the pedal effort, and an internal pad disposed along a rear surface of the external pad, and wherein the cover comprises an internal cover connected to the internal pad with the vibration producer disposed between the internal cover and the internal pad, the cover further comprising an external cover which is disposed along a rear surface of the internal cover.

5. The accelerator pedal for a vehicle according to claim 4, wherein the internal pad and the internal cover are elastic members configured for soundproofing and noise reduction.

6. The accelerator pedal for a vehicle according to claim 1, further comprising a wiring to transmit the electric signal to the vibration producer.

7. The accelerator pedal for a vehicle according to claim 6, wherein the wiring comprises a curved portion adjacent a portion of the foot pad, wherein the curved portion is rotated by pedal effort, the wiring further comprising an angled portion extending from the curved portion and overlapped by the curved portion.
